(19) United States
(12) Patent Application Publication
(10) Pub. No.: US 2007/0089150 A1
(43) Pub. Date: Apr. 19, 2007

(54) Interactive advertising system and method

(76) Inventor: Howard Bowler, Teaneck, NJ (US)

Correspondence Address: BOND, SCHOENECK & KING, PLLC, ONE LINCOLN CENTER, SYRACUSE, NY, 13202-1355, US

(21) Appl. No.: 11/249,577

(22) Filed: Oct. 13, 2005

(51) Int. Cl. H04N 7/025; H04N 7/173; H04N 7/10; H04N 5/445; G06F 3/00; G06F 13/00

(52) U.S. Cl. 725/113; 725/112; 725/32; 725/60

(57) ABSTRACT

A system and method for creating new commercials, or repurposing conventional broadcast advertisements, to include viewer interactivity. From either a tape based or digital format, a particular television spot is converted into a computer file, such as an mpg file. The computer file containing the advertisement is then loaded into a conventional software program, such as Flash, which can display the commercial. The computer file containing the advertisement is then embedded with links for allowing a viewer to link to websites related to the products or services displayed in the commercial, such as retailer or dealer websites.

### BACKGROUND OF THE INVENTION

1. Field of Invention

The present invention relates to television advertising and, more specifically, to a method and system for providing interactive advertising to conventional and internet based television broadcasts.

2. Description of Prior Art

Conventional television advertising comprises the broadcasting of static advertisements, such as sixty second spots and longer infomercials, between regular programming spots. During non-commercial programming, viewers are often exposed to many different forms of products and services and cannot access information about the products and services directly. Instead, viewers must watch the remainder of the programming and then search other media outlets for information about the products or services, such as the internet.

3. Objects and Advantages

It is a principal object and advantage of the present invention to provide a system and method for providing interactive advertising with conventional television programming.

It is an additional object and advantage of the present invention to provide a system and method for providing interactive advertising with internet-based television broadcasting.

Other objects and advantages of the present invention will in part be obvious, and in part appear hereinafter.

### SUMMARY OF THE INVENTION

The present invention comprises a system and method for creating new commercials, or repurposing conventional broadcast advertisements, to include viewer interactivity. From either a tape based or digital format, a particular television broadcast is converted into a computer file, such as an mpg file. The computer file containing the programming spot is then loaded into a conventional software program, such as Flash, which can display the broadcast segment. The computer file containing the broadcast segment is then embedded with links to allow a viewer to link directly to the websites of the manufacturers and/or retailers of products or services featured or appearing in the broadcast segment.

The method and system of the present invention operates on both Apple and PC platforms, and includes web-casting stations and wireless applications. The method and system allows a viewer to watch a program/commercial and, while it is playing, have the option to pause the show and click through with a mouse or remote device to websites providing more information or purchasing options for the products or services seen in the program. When the transaction is complete, the viewer can return to programming to view the rest of the show uninterrupted. With currently available technology, the pausing of a commercial is possible if it is interactive, but with conventional broadcasts, the broadcaster would have to permit some form of control over the broadcast in order for the service provider of the present invention to pause the program.

### BRIEF DESCRIPTION OF THE DRAWINGS

The present invention will be more fully understood and appreciated by reading the following Detailed Description in conjunction with the accompanying drawings, in which:

FIG. 1 is a schematic of a first step of a method according to the present invention.

FIG. 2 is a schematic of a second step of a method according to the present invention.

FIG. 3 is a schematic of a third step of a method according to the present invention.

FIG. 4 is a high-level schematic of a system according to the present invention.

FIG. 5 is a high-level schematic of a system according to the present invention.

FIG. 6 is a schematic of another embodiment of a system according to the present invention.

### DETAILED DESCRIPTION

Referring now to the drawings, wherein like numerals refer to like parts throughout, there is seen in FIG. 1, the first step in creating a commercial according to the present invention or repurposing an existing broadcast television spot according to the present invention to contain interactive advertising. First, if necessary, a television spot 10 previously recorded onto a digital tape is converted into a digital computer file 12. For example, a conventional television program or spot saved on videotape 10 may be converted into a digital .mpg file. If program 10 is already in mpg or other digital computer format, this step may be omitted.

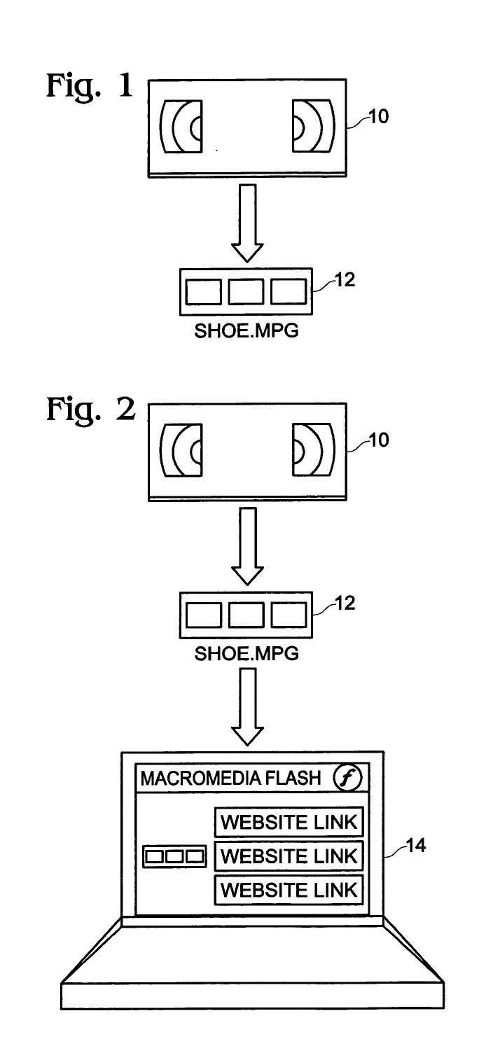

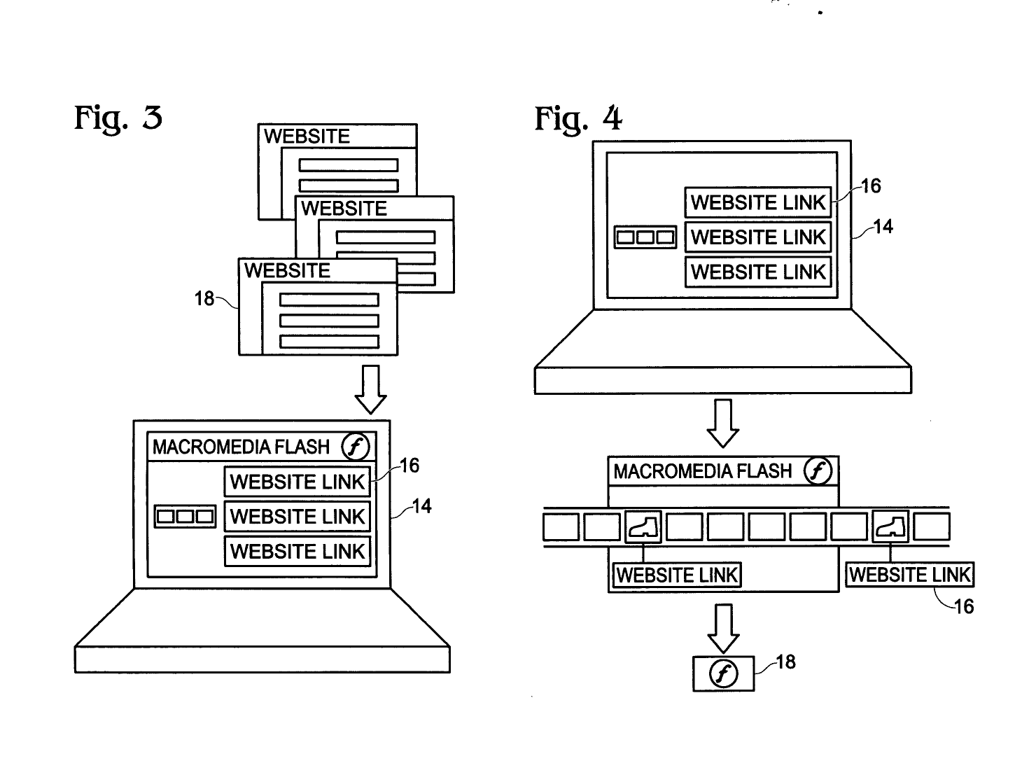

As seen FIG. 2, computer file 12 is loaded into a multimedia software program 14, such as Flash available from Macromedia, Inc. of San Francisco, Calif., for electronically displaying program on a computer. Referring to FIG. 3, software program 14 is next embedded or associated with links 16 representing the products or services appearing in program 10. For example, program 10 may be a shoe commercial, and links to the manufacturer of the shoe and, if applicable, retailers of the shoes are intermingled with spot 10 so that a viewer can easily point and click on the product. As seen in FIG. 3, links 16 allow a viewer to simultaneously display websites 18 for the retailers or dealers of the products or services which are the subject of the advertisement of file 12. Meanwhile, spot 10 is paused so that the viewer can assimilate the information gleaned from viewing links 16.

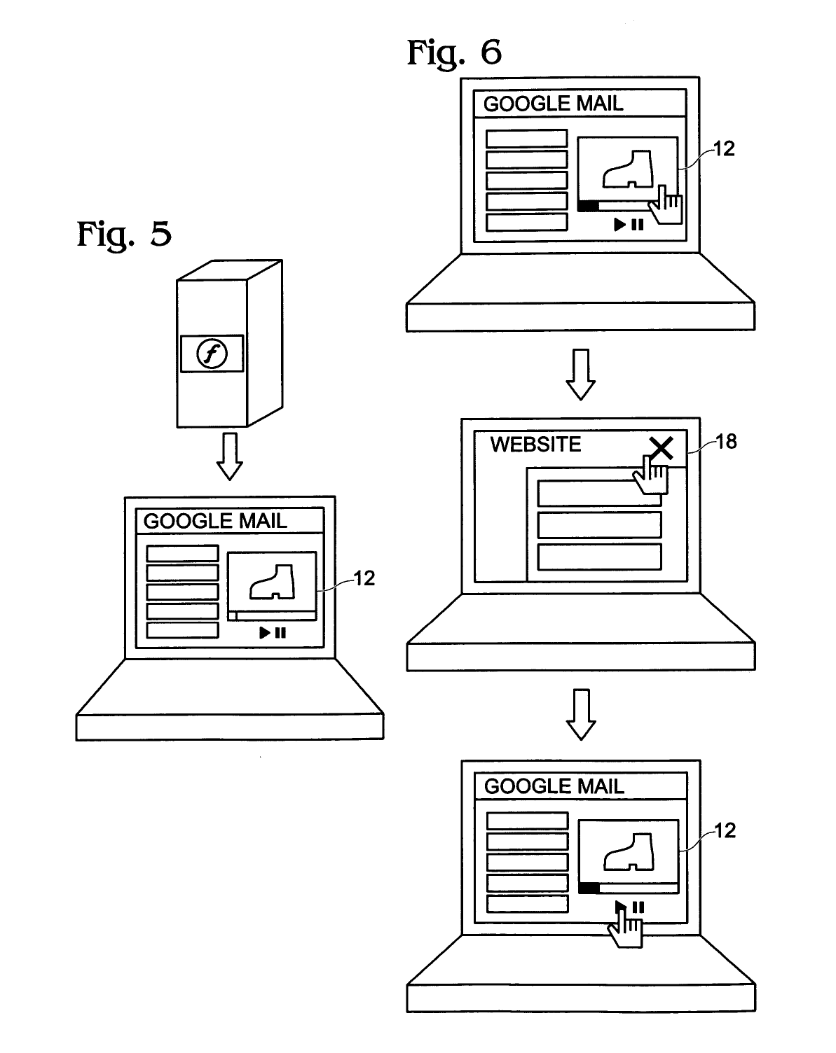

Referring to FIG. 4, viewers of software program 14 can thus see traditional or interactive television programming spots 10 and immediately link to products and/or services which appear in spot 10. In this manner, the viewer has the option of immediately purchasing the product or service interactively through the internet by using links 16 to load manufacturer and retailer websites 18. As seen in FIG. 5, the present invention blends the traditional television experience with the option of an interactive experience that allows a viewer to immediately purchase the displayed products by interacting with the viewing of spot 10.

Referring to FIG. 6, a file 12 comprising a commercial may delivered to viewer via a conventional email provider 20 through known profiling techniques and available consumer data. The viewing of file 12 can be paused while the viewer connects to websites 18 of retailer and dealers, and then resumed after the viewer examines more detailed information about the product or service and closes website 18.

Numerous files 12 containing advertisements or spots retrofitted with interactive advertising may be stored in a central server, website, or wireless distribution source and fed to prospective viewers via the internet or via email. When a prospective viewer retrieves email, the service provider, such as Google, determined the interests of the viewer and feeds appropriate commercials or programming spots to the viewer.

What is claimed is:

1. A system for interactive advertising comprising:
a server having digital storage media;
a computer file stored on said digital storage media, further comprising a digitized video advertisement that depicts a product;
wherein said digitized video advertisement is capable of display over a network and wherein said digitized advertisement includes an embedded hyperlink.

2. The system of claim 1, wherein activation of said hyperlink causes presentation of information related to said product.

3. The system of claim 1, wherein activation of said hyperlink causes presentation of purchasing information for said product.

4. The system of claim 1, wherein said embedded hyperlink is associated with said product as it is depicted over said network.

5. The system of claim 4, wherein said embedded hyperlink moves with said product as it is depicted over said network.

6. A method of providing interactive advertising comprising the steps of:
providing a digitized advertisement that depicts a product;
embedding a hyperlink in said digitized advertisement;
displaying said digitized advertisement; and
providing information related to said product in response to user activation of said hyperlink.

7. The method of claim 6 wherein the step of providing a digitized advertisement includes converting analog video to a digital file.

8. The method of claim 6 wherein the step of embedding a hyperlink includes associating said hyperlink with the depiction of said product.

9. The method of claim 6 wherein the step of displaying said digitized advertisement includes displaying said advertisement over a network.

10. The method of claim 9 where in said network is a global interactive network.

11. The method of claim 6 wherein the step of providing information related to said product includes offering said product for sale.

12. The method of claim 6 further comprising the step of transmitting said digitized advertisement in email.

13. The method of claim 6 further comprising the step of transmitting said digitized advertisement in an instant message.
